(19) United States
(12) Patent Application Publication
(10) Pub. No.: US 2021/0000072 A1
(43) Pub. Date: Jan. 7, 2021

(54) GRAVITY-FED PET WATER DISH AND RESERVOIR

(71) Applicants: Timothy A. Miller, Tipton, IN (US); Diana Lyn Miller, Tipton, IN (US)

(72) Inventors: Timothy A. Miller, Tipton, IN (US); Diana Lyn Miller, Tipton, IN (US)

(21) Appl. No.: 16/916,513

(22) Filed: Jun. 30, 2020

Related U.S. Application Data
(60) Provisional application No. 62/869,024, filed on Jul. 1, 2019.

(51) Int. Cl. A01K 7/02

(52) U.S. Cl. CPC A01K 7/025; A01K 7/005

(57) ABSTRACT

The gravity-fed pet water dish and comes with its custom-made water jug reservoir and a water bowl designed specifically for the water jug. The water jug has an extended and customized neck to allow the jug to fit through the base of the water bowl. Once the water jug and its base are fully connected, the water will dispense until the bowl is full, and then will continue to dispense as needed to keep the bowl full. When secured in place, the custom-made water jug is 3 cm off the floor of the bowl. This makes it possible for enough water to be dispensed onto the water bowl and prevents any splashes of water that occur with regular water bowls.

### CROSS-REFERENCE TO RELATED APPLICATION

The present application is related to and claims priority from prior provisional application Ser. No. 62/869,024, filed Jul. 1, 2019, the entire application of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of pet supplies and water holders bowls. More specifically, the invention is a gravity-fed pet or animal water dish with a water reservoir and a shallow water bowl.

### 2. Description of the Related Art

As of now, current water bowls do not prevent any messes when pets begin to drink from them. Because of this, pet owners have to constantly clean dog drool and splashes of water in areas around the water bowl. Additionally, some pets won't drink stale water, or may run out of water during the day when their owner is at work. Therefore, a need exists for a product that will help keep the floor dry while dispensing water for pets.

Various attempts have been made to solve the problem of water messes around pet water bowls, which may be found in the related art, but have thus far been unsuccessful. A need therefore exists for a reliable gravity-fed pet water dish and reservoir to avoid the above-mentioned problems.

### BRIEF SUMMARY OF THE INVENTION

In view of the foregoing disadvantages inherent in the known art, the present invention provides a novel gravity-fed pet water dish and reservoir. The general purpose of the present invention, which will be described subsequently in greater detail, is to provide a shallow water bowl structured and arranged to replace current water bowls with its innovative water jug.

The gravity-fed pet water dish and reservoir is an innovative take on pet water bowls. The gravity-fed pet water dish and reservoir allows your pets to drink more water without the worry of over-drinking. Because of its shallow water depth, pets can now drink water without the excess drool that follows. When secured in place, the custom-made water jug is 3 cm off the floor of the bowl. This makes it possible for enough water to be dispensed onto the water bowl and prevents any splashes of water that occur with regular water bowls.

The gravity-fed pet water dish and comes with its custom-made water jug reservoir and a water bowl designed specifically for the water jug. The water jug has an extended and customized neck to allow the jug to fit through the base of the water bowl. Once the water jug and its base are fully connected, the water will dispense until the bowl is full, and then will continue to dispense as needed to keep the bowl full. The gravity-fed pet water dish and reservoir will replace current water bowls with its ingenious water jug and its novel water bowl base.

The unique features of the presently claimed invention provide a number of benefits, including: (1) protecting the floor and surrounding furniture from drool and excess water splashes by dispensing a shallow amount of water that is enough to satisfy the pet's thirst as it continues to refill; and (2) the custom-made water jugs will securely connect with the water dish to prevent the pet from knocking the reservoir over.

The present invention holds significant improvements and serves as a gravity-fed pet water dish and reservoir. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a gravity-fed pet water dish and reservoir, constructed and operative according to the teachings of the present invention.

FIG. 1 shows a perspective view illustrating a water jug reservoir according to an embodiment of the presently claimed invention.

FIG. 2 is a perspective view illustrating a water jug reservoir interlocking with a pet water dish according to an embodiment of the presently claimed invention.

FIG. 3 is a perspective view illustrating a gravity-fed pet water dish and water jug reservoir according to an embodiment of the presently claimed invention.

FIG. 4 is a perspective view illustrating a water dish with a support and interlocking part for a water jug reservoir according to an embodiment of the presently claimed invention.

The various embodiments of the present invention will hereinafter be described in conjunction with the appended drawings, wherein like designations denote like elements.

### DETAILED DESCRIPTION

As discussed above, embodiments of the present invention relate to a pet water dish and more particularly to a gravity-fed pet water dish and reservoir as used to improve the availability of fresh water and reduce the number of spills when a pet drinks from the bowl.

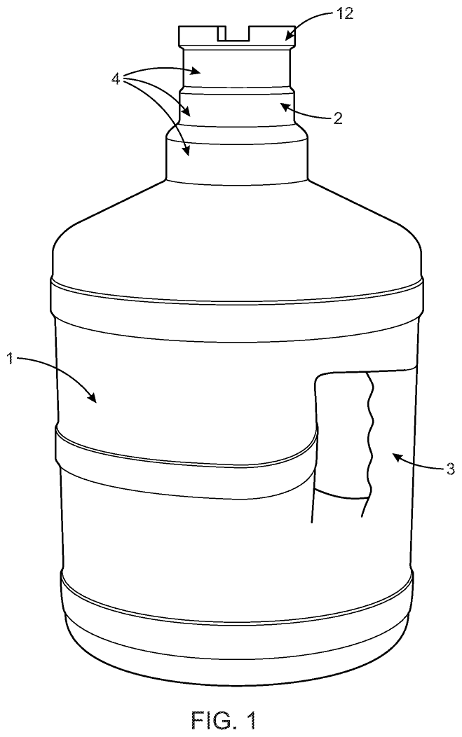

Referring to the drawings by numerals of reference there is shown in FIG. 1, the water jug reservoir 1 is a jug with an extended neck 2 with a narrow opening 12 at one end through which the reservoir 1 can be filled with water. The reservoir 1 has a handle 3 on one side for ease in filling, carrying, and positioning the reservoir 1. The outside of the extended neck 2 has slots 4 that interlock with the slots 10 of the water dish 5. The reservoir 1 is preferably made of a translucent material, such as pet-safe, BPA-free plastic, so the level of water remaining is easy to see.

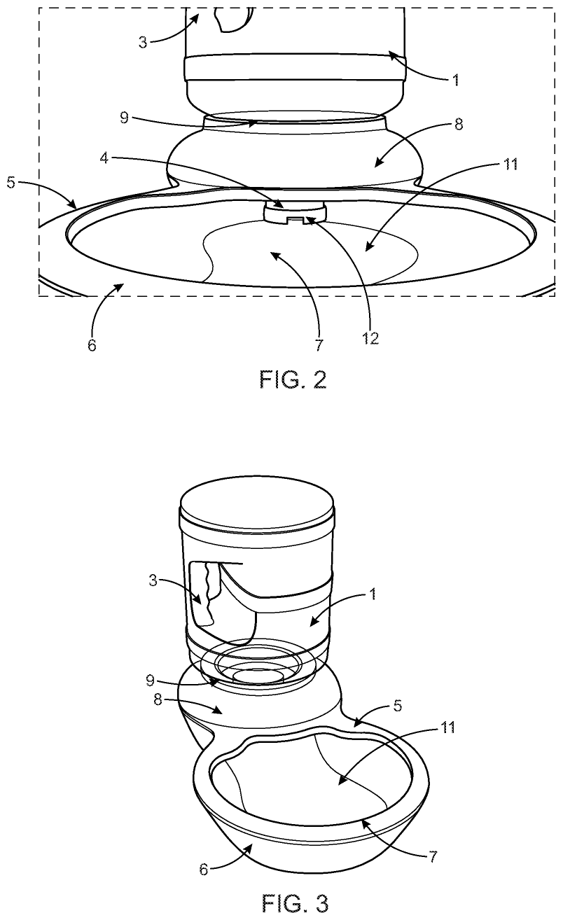

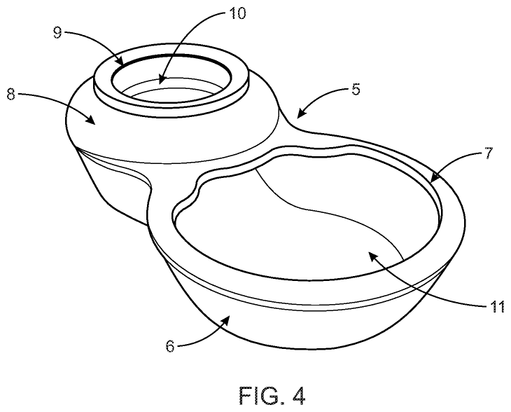

As shown in FIGS. 2-4, the pet water dish 5 has a shallow bowl section 6 with a wide opening 7 in the front. In the back, the water dish 5 is enclosed by the reservoir support portion 8. The reservoir support portion 8 has an opening 9 with interlocking slots 10 that secure the water jug reservoir 1 in place. When slotted in place, the reservoir 1 rests on the reservoir support portion 8 in an upside down position so that the extended neck 2 of the reservoir 1 is pointed directly downward through the opening 9 in the reservoir support portion 8.

When secured in place, the narrow opening 12 of the water jug reservoir 1 is 3 cm off the inside base 11 of the bowl 5. As water evaporates or is drunk by the pet, gravity feeds more water out the narrow opening 12 to refill the water dish 5.

The water bowl made be formed from any pet-safe material, including but not limited to, plastic, metal, and ceramic.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A gravity-fed pet water dish and reservoir system comprising:
(a) a water jug reservoir having
(i) a reservoir body;
(ii) an extended neck having
(1) a narrow opening; and
(2) one or more slots, tabs, or bumps;
(iii) a handle; and
(b) a water bowl having
(i) a shallow bowl section having
(1) a wide opening; and
(2) an inside base;
(ii) a reservoir support section having
(1) an opening with one or more slots, tabs, or bumps along an inside rim,
wherein the one or more slots, tabs, or bumps along the inside rim of the reservoir support section are operably designed to interlock with the one or more slots, tabs, or bumps on the extended neck of the water jug reservoir,
wherein the extended neck of the water jug reservoir points directly downward so a vertical axis of the water jug reservoir is perpendicular to the inside base of the water bowl when the water jug reservoir is interlocked with the reservoir support section of the water bowl, and wherein the narrow opening of the extended neck of the water jug reservoir is 3 cm above the inside base of the water bowl when the water jug reservoir is interlocked with the reservoir support section of the water bowl.

2. The gravity-fed pet water dish and reservoir system according to claim 1, wherein the water jug reservoir is formed of a translucent, pet-safe, BPA-free plastic material.

3. The gravity-fed pet water dish and reservoir system according to claim 1, wherein the water bowl portion is formed from a material selected from the group consisting of plastic, metal, and ceramic.
